(19) United States
(12) Patent Application Publication
(10) Pub. No.: US 2009/0020689 A1
(43) Pub. Date: Jan. 22, 2009

(54) Optical Detection System

(75) Inventors: Henryk Frenzel, Regensburg (DE); Harald Schmidt, Regensburg (DE)

Correspondence Address: LERNER GREENBERG STEMER LLP, P O BOX 2480, HOLLYWOOD, FL, 33022-2480, US

(73) Assignee: Continental Automotive GmbH, Hannover (DE)

(21) Appl. No.: 12/278,410

(22) PCT Filed: Jan. 8, 2007
(86) PCT No.: PCT/EP07/50131

§ 371 Date: Aug. 6, 2008

(30) Foreign Application Priority Data
Feb. 7, 2006 (DE) 10 2006 005 519.5

(51) Int. Cl. H01J 40/14

(52) U.S. Cl. 250/215

(57) ABSTRACT

An optical detection system has a component support, in which is disposed at least one optical element, and a separate detector unit having a mechanical connection to the component support. The component support and the detector unit are arranged in such a way that light entering into the component support can be guided through the at least one optical element to the detector unit and that the mechanical connection between the component support and the detector unit is configured in a releasable manner by means of a retaining element which is detachably connected to the component support and the detector unit.

The invention relates to an optical detection system comprising a component support in which at least one optical element is disposed, and a separate detector unit which is mechanically connected to the component support, wherein the component support and the detector unit are disposed in relation to one another such that light entering the component support may be guided through the at least one optical element to the detector unit.

EP 1 220 324 A2 discloses an optical detection system in which, in one embodiment, a component support including a lens is set on a detector housing in which a CCD or CMOS sensor is disposed. The detector housing is mounted on a printed circuit board. A respective separate spring element is disposed at each corner region of the quadrilateral detector housing, the spring elements being non-detachably connected to the detector housing, for example by being soldered on. The optical detection system has a plurality of individual spring elements which extend substantially only vertically in the direction of the component support. Each spring element has a recess in which, in the assembled condition of the component support and the detector housing, a respective pin-like element constructed on the component support engages.

Optical detection systems are also used more and more in vehicles, and serve to detect the environment of the vehicle. This information can then be provided to a driver assistance system, with the optical detection system forming part of the driver assistance system. Then, as a function of the information detected by the optical detection system, in particular the images, the driver assistance system can if appropriate automatically intervene in the drive behavior of the vehicle. The information may also be provided to a blind spot detection system or an aid to parking. Furthermore, optical detection systems may also be provided for observing the interior of the vehicle, in particular passengers. The information obtained may be provided to a security system or passenger protection system. For example, the deployment behavior of an airbag may be controlled as a function of this information.

Optical detection systems of this kind may be camera systems, which conventionally have an image sensor, for example a CCD sensor or CMOS sensor, and an associated optical device. The connection between the optical device and for example a board assembly which also includes the image sensor must be made extremely precisely so that in principle an image can be recorded on the image sensor. Very narrow tolerances necessarily mean geometric redundancies. An additional difficulty, in particular when systems of this kind are used in the automotive engineering sector, is that thermal loads which create reversible deformations of the elements have to be taken into account. These deformations resulting from thermal loads have to be compensated over a relatively long period of several years. Moreover, as a result of requirements for recycling, which are becoming more and more stringent and restrictive, the need to sort a vast variety of elements and components into their different types has also to be met. This means that the possible techniques for connecting the different elements of the optical detection system are additionally restricted.

In current manufacturing technology, the component support is firmly connected to the detector unit for example by an adhesive connection, and it is not possible to detach these two elements again. This means that movement of the parts in all three directions in space, caused by thermal effects, is completely blocked. Thus, reversible movements are not possible. Moreover, during manufacture extreme precision is required when joining the component support and the detector unit by an adhesive connection so that the individual parts, in particular an image sensor and optical elements, are not contaminated by adhesive. Since this cannot be absolutely guaranteed, however, it leads to a high error rate. The result is a detection system which does not work properly and which has to be rejected. Not only that, but the high requirement of precision in an adhesive connection means that manufacture also takes a relatively long time, which also increases costs.

It is thus the object of the present invention to provide an optical detection system which has a simple mechanical connection, which can be achieved at low cost, between a component support and a detector unit.

This object is achieved by an optical detection system having the features of claim 1.

An optical detection system according to the invention includes a component support in which at least one optical element is disposed. The optical detection system further includes a separate detector unit which is mechanically connected to the component support. The detector unit and the component support are in this arrangement disposed in relation to one another such that light entering the component support may be guided through the at least one optical element in the component support to the detector unit. The term “light” covers both the visible and the invisible wavelength ranges, so in particular the infrared and ultraviolet wavelength ranges are also included. It is an essential concept of the invention that the mechanical connection between the component support and the detector unit is constructed to be releasable. For this, a retaining element is provided as a separate part and is constructed to releasably connect the component support to the detector unit. The retaining element itself is also releasably connected both to the component support and to the detector unit. This makes it possible on the one hand to connect these two elements simply and at low cost. On the other hand, it makes it possible to release and secure the elements quickly and reliably, and in reversible manner. Moreover, a releasable construction of this kind means that these two elements can be moved reversibly in relation to one another in all three directions in space, and yet for a mechanical connection which enables an image to be received reliably and precisely by the detector unit to be provided. As a result of this releasable connection, it is possible in particular to take account of high thermal demands and hence expansions and contractions of the individual elements, and a reliable compensation of tolerances is made possible under virtually all possible conditions. The term “releasable connection” here covers all those connections which make it possible to join and take apart the mutually connected elements in reversible manner and without damage. The optical detection system is thus of modular construction and may simply be detached and joined together again, for example for repair or replacement. Individual modules may be considered separately, and a high degree of flexibility of the said system is ensured because the individual elements are provided separately.

Preferably, the optical detection system has only a single retaining element. This enables a reduced complexity of the components and faster mounting. It also makes it possible to take account of the requirement for reduced costs. However, it is also possible for at least two separate retaining elements to be provided.

Advantageously, the component support and the detector unit are releasably connected to one another by a retaining element which is flexible at least in certain regions. Preferably, the retaining element which is flexible at least in certain regions is constructed as a spring element. The flexible construction allows reliable compensation of tolerances. This makes it possible to ensure that sufficient contact pressure is generated, allowing the component support and the detector unit to be held securely together in a first direction in space (z direction), and with vibration of the assembly not resulting in the two elements being moved away from one another.

Preferably, the retaining element which is flexible at least in certain regions may be constructed in the manner of a clamp. It is also possible to provide for the retaining element to be in the shape of a bridge. The retaining element which is flexible at least in certain regions may be shaped such that it has a region of connection and at least two retaining limbs, with the retaining limbs disposed at opposing sides of the region of connection. The flexible retaining element may be of such a size that by means of the retaining limbs it bears against the edge regions of the detector unit and so reaches around the latter in the manner of a bridge or clamp.

Advantageously, each retaining limb has a free end which has a curved profile. This makes it possible to secure the retaining element securely and means that the retaining element can be attached force-fittingly, and also where appropriate form-fittingly, to the detector unit and/or the component support.

Advantageously, in the assembled condition of the detection system, the curved profile of a free end abuts against an underside of the detector unit facing away from the component support. This enables a particularly effective mechanical connection, since the retaining element reaches around the detector unit and the component support and holds them together as a result of a contact pressure that is generated. It may be provided for cutouts to be made in this underside of the component support and for the curved profile of the free end to engage therein. In this case, the engagement may also be of latching type. This means a particularly secure positioning of the retaining element may be ensured. In this embodiment and with this disposition of the retaining element, the latter is set on the component support and reaches around the component support and the detector unit in a manner which may be regarded as from “above”.

It may also be provided for the retaining element to be set on the underside of the detector unit and to reach around the detector unit and the component support from “below”. The curved profiles of the retaining element then preferably abut against the component support.

The region of connection of the retaining element may preferably be constructed in the shape of a cup. It may also be provided for the region of connection to have at least one through cutout which may in particular be a cutout hole having an angled or cornerless shape. Advantageously, in the assembled condition of the detection system, the component support extends through this cutout, it being possible for the region of connection to abut at least in certain regions against the component support. This means that the retaining element can create a firm mechanical connection between the component support and the detector unit which may be regarded as in all three directions in space, and yet a required compensation of tolerance between these two elements can be ensured.

Preferably, the cutout in the region of connection is dimensioned such that the region of connection abuts at least in certain regions against the component support in peripheral manner.

Preferably, the cutout is shaped such that the region of connection extends over the complete periphery of the component support and in particular abuts against the component support around the complete periphery. This makes a disposition with snug fit possible.

It may be provided for the retaining element which is flexible at least in certain regions to be made at least partly from metal or at least partly from synthetic material. Depending on the situation, and depending on the point of use, this allows the design of a retaining element which takes optimum account of the respective requirements. This requirement may relate to environmental conditions, weight or cost.

It is also possible for the component support to be made at least partly from metal or at least partly from synthetic material.

Advantageously, the detector unit has at least one blocking means, in particular a groove, in which, in the assembled condition of the detection system, an engagement element of the component support engages. This engagement may in particular be of latching type. As a result of this construction, twisting of the two components in relation to one another about an axis parallel to the axis of the groove can be prevented. In principle, any other measure may be taken to prevent this kind of twisting of the two elements in relation to one another. The blocking means of the detector unit may take the form of a depression, in particular a groove, in which a pin element of the component support engages. However, it is also possible to provide for a raised engagement element to be constructed on the detector unit and for this to engage in a preferably snugly fitting depression or cutout in the component support.

Advantageously, it is further provided for the retaining element which is flexible at least in certain regions to be constructed on a housing for the purpose of releasable securing of the entire optical detection system. This means that the retaining element can not only ensure a secure releasable connection between the component support and the detector unit but also enable a secure and low-cost attachment of the entire optical detection system to a housing.

Advantageously, the detector unit includes an image sensor. The image sensor may be constructed for example as an MQFP (metric quad flat pack) sensor. This optical MQFP sensor may be a CCD sensor or a CMOS sensor. MQFP sensors of this kind are relatively small in construction and hence take up little space and make multiple contacts possible, since they preferably have points for electrical contact on all edge regions.

The component support is advantageously constructed as a lens tube. Preferably, a plurality of lenses is disposed in the component support and enables the light entering to be guided to the detector unit.

Advantageously, the optical detection unit is associated with a driver assistance system or passenger protection system and is disposed in a vehicle, in particular a vehicle interior, or on the outside of the vehicle, for example in a bumper or an outside mirror. This means that the or these system data detected by the optical detection unit, for example external spatial information such as the clearance from another vehicle, or internal spatial information such as the precise occupancy of the seat, can be used in particular as input data, that is to say as data used for a subsequent action such as braking or disabling the airbag, for example if a child seat is located there.

Exemplary embodiments of the invention will be explained in more detail below with reference to schematic drawings, in which:

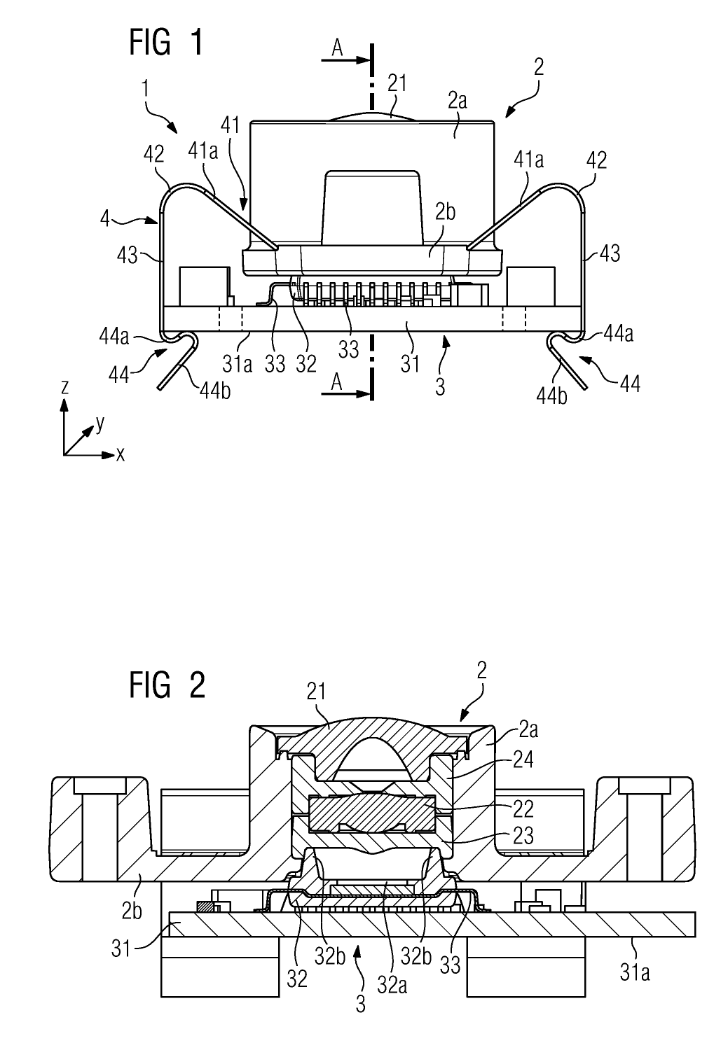

FIG. 1 shows a cross-sectional illustration of an exemplary embodiment of the optical detection system;

FIG. 2 shows a further sectional illustration of the optical detection system along the line of section AA from FIG. 1;

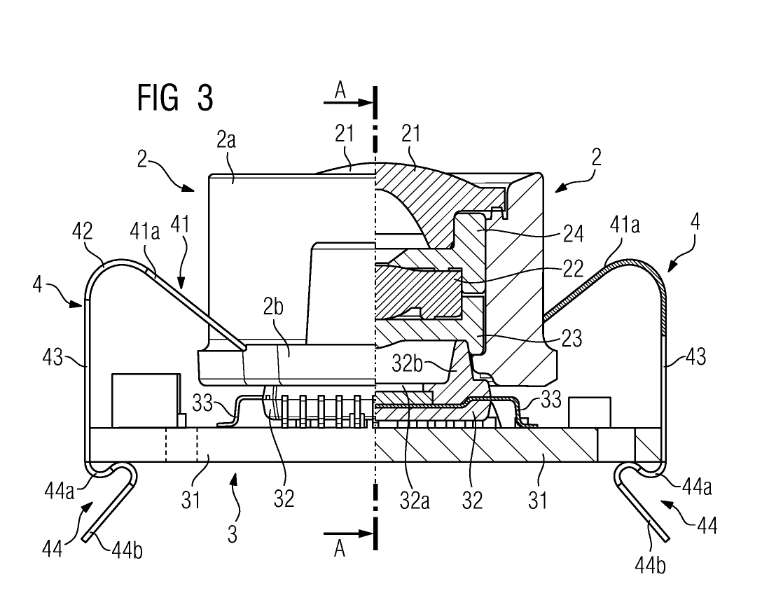

FIG. 3 shows, joined together, an illustration of partial regions of the embodiments in FIGS. 1 and 2;

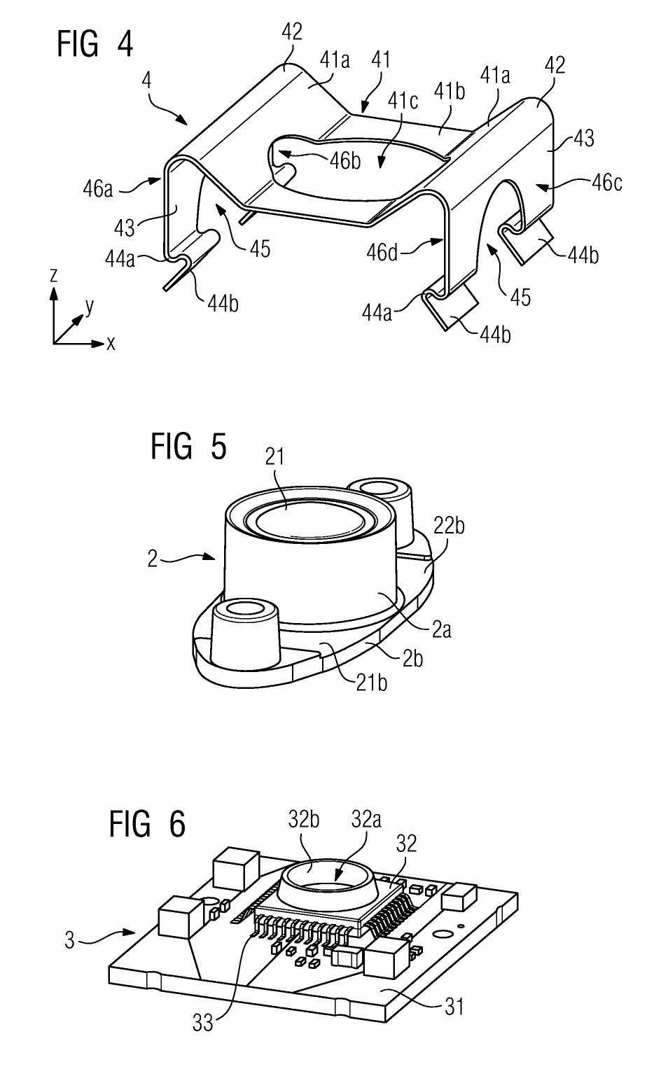

FIG. 4 shows a perspective illustration of a retaining element of the optical detection system according to a first embodiment;

FIG. 5 shows a perspective illustration of a component support of the optical detection system according to a first embodiment;

FIG. 6 shows a perspective illustration of a detector unit of the optical detection system according to a first embodiment;

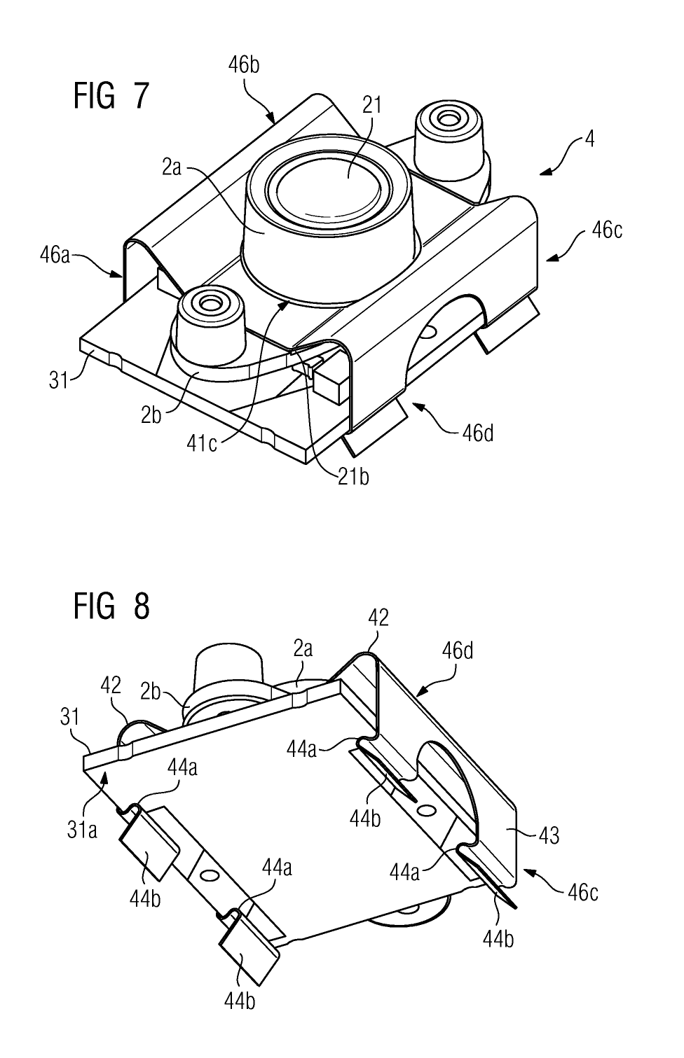

FIG. 7 shows a first perspective illustration of an assembled optical detection system according to a first embodiment;

FIG. 8 shows a second perspective illustration of an assembled optical detection system according to the first embodiment;

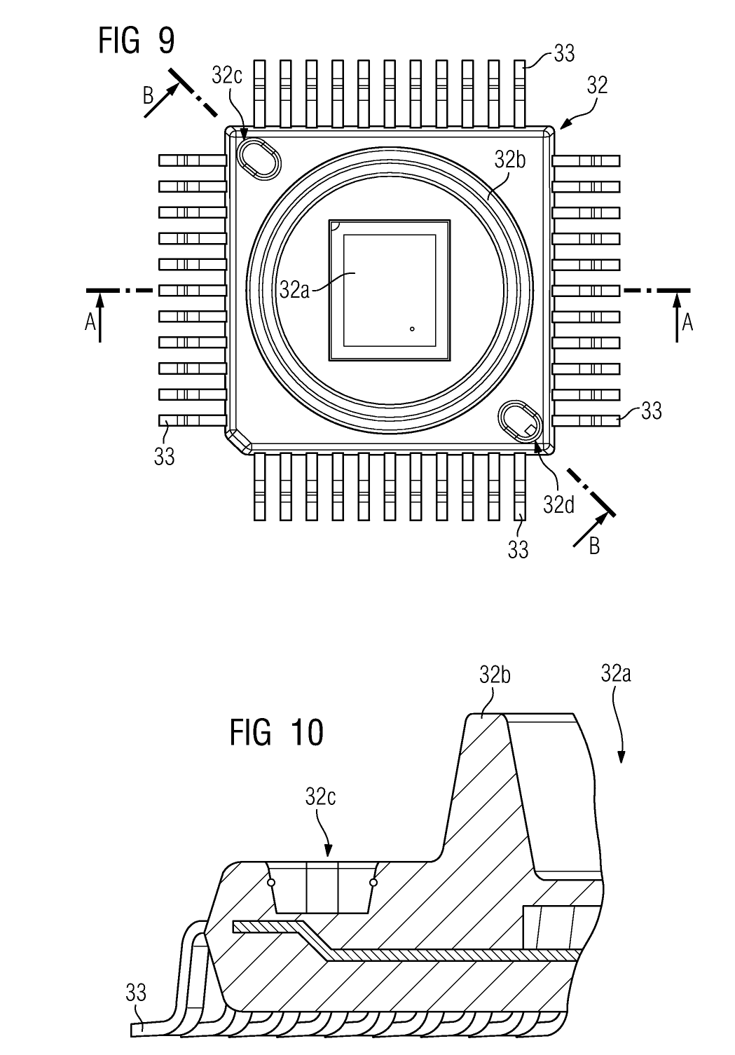

FIG. 9 shows a schematic plan view of a sensor housing of the detector unit of a first embodiment;

FIG. 10 shows a sectional illustration along the line of section BB in FIG. 9;

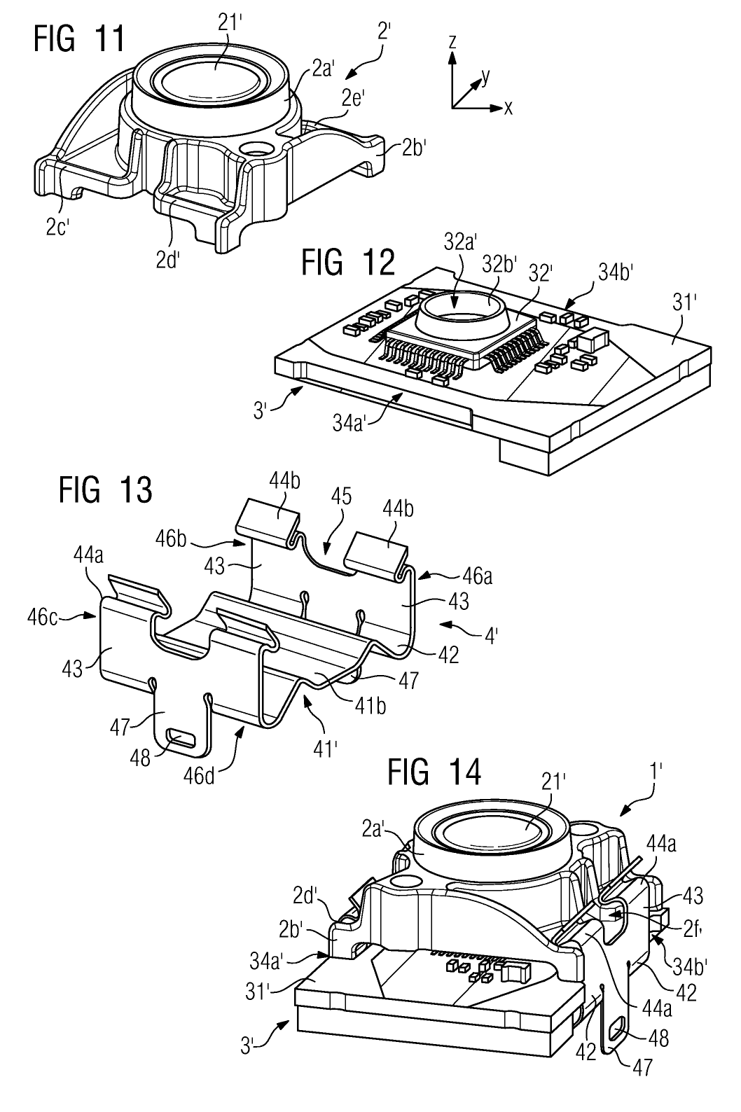

FIG. 11 shows a perspective illustration of a component support of the optical detection system according to a second embodiment;

FIG. 12 shows a perspective illustration of a detector unit of the optical detection system according to a second embodiment;

FIG. 13 shows a perspective illustration of a retaining element of the optical detection system according to a second embodiment; and

FIG. 14 shows a second perspective illustration of an assembled optical detection system according to the second embodiment.

In the figures, like or functionally equivalent elements are given the same reference numerals.

FIG. 1 shows a schematic cross-sectional illustration of an optical detection system 1. In the exemplary embodiment, the optical detection system 1 is disposed in an interior of a vehicle and is constructed to detect environmental conditions of the vehicle. The environmental conditions detected by the optical detection system 1 are provided to a driver assistance system with which the optical detection system 1 is associated. As a function of these detected environmental conditions, the driver assistance system can if appropriate automatically intervene in the drive behavior of the vehicle. The driver assistance system may in this case take the form of an LDW (lane departure warning) or ACC (adaptive cruise control) system. However, this is purely exemplary, and the driver assistance system may also be of another construction.

The optical detection system may be constructed and disposed for the purpose of monitoring the interior and may be associated for example with a passenger protection system which, as a function of the information from the optical detection system, controls for example the deployment of one or more airbags.

The optical detection system 1 has a component support 2 and an optical detector unit 3. In the exemplary embodiment, the component support 2 is constructed as a lens tube in which a plurality of optical elements, in particular lenses, is disposed. By way of example thereof, a lens 21 can be seen in FIG. 1.

The component support 2 and the detector unit 3 are mechanically connected to one another in releasable manner by a single retaining element 4 which is constructed to be flexible at least in certain regions. The retaining element 4 is constructed as a separate part and is releasably connected to the component support 2 and the detector unit 3. As a result of the retaining element 4, a mechanical connection may be made between the component support 4 and the detector unit 3 and enables a tolerance compensation in all three directions in space (z, y and x directions). The retaining element 4 ensures a rapid and low-cost reversible securing or connection without damage, and a corresponding release of the component support 2, to and from the detector unit 3.

The component support 2 and the detector unit 3 are disposed in relation to one another such that light entering through the lenses 21 from the outside can be guided through the component support 2 and the optical elements disposed therein to the detector unit 3. As can be seen from the illustration in FIG. 1, the component support 2 has a component housing 2a in which the optical elements are disposed. The component housing 2a is mounted on a component base 2b, in particular being constructed in one piece therewith. The component support 2 is constructed such that the component housing 2a and in particular the component base 2b are shaped in such a way as to enable them to be set with snug fit on the detector unit 3.

The detector unit 3 is constructed as a board assembly which includes a rigid printed circuit board 31 on which a plurality of electronic components is disposed. In particular, disposed on the printed circuit board 31 is a sensor housing 32 in which an image sensor 32a which is not visible (see for example FIG. 2) is disposed. The image sensor 32a and the sensor housing 32 are constructed as an MQFP sensor. As can be seen here, a plurality of electrical contacts 33 is constructed on the sensor housing 32 in peripheral manner, on all the edge regions.

In the exemplary embodiment, the retaining element 4 which is flexible at least in certain regions is constructed as a spring element and has a bridge-like structure. As can be seen in this regard from the illustration in FIG. 1, the retaining element 4 is constructed, at least in the cross-sectional illustration shown, to have substantially the same width as the printed circuit board 31. The retaining element 4 has a region 41 of connection which is constructed to be cup-shaped. For this, the region 41 of connection has sloping edge regions 41a and a horizontal part 41b which cannot be seen in FIG. 1 (see for example FIG. 4).

The region 41 of connection merges on both sides into curved transitional regions 42 which then merge into substantially vertically oriented parts 43. These parts 43, which in the illustration shown are vertical, then each merge into free ends 44. As can be seen, the free ends 44 each have a curved profile 44a, which in the exemplary embodiment is in the shape of an S, and a straight end piece 44b.

In the assembled condition, the retaining element 4 thus reaches around the component support 2 and the detector unit 3, from above in the illustration shown, such that these two elements 2 and 3 are clamped by the retaining element 4. As can be seen in this regard from the illustration in FIG. 1, in this arrangement the component support 2 projects through a cutout (not visible) in the region 41 of connection, and the retaining element 4 presses the component support 2 against the detector unit 3 as a result of the shaping and disposition described. At the same time, the curved profiles 44a abut against an underside 31a of the printed circuit board 31. In the embodiment shown, the printed circuit board 31 does not have a cutout in the region of the curved profiles 44a. However, it is also possible to provide for cutouts to be made in the region in which the curved profiles 44a abut against the underside 31a of the printed circuit board 31 such that the curved profiles 44a engage in these cutouts at least in certain regions. This allows a particularly favorable positioning of the retaining element 4, form-fitting and force-fitting, to be ensured.

The curved profiles 44a and the end pieces 44b are preferably shaped such that the retaining element 4 can simply be mounted on the detector unit 3 and in particular the printed circuit board 31. In this arrangement, the end pieces 44b are bent outwards so that simple pushing on and snap-fitting of the retaining element 4 can be achieved, in particular over the edge of the printed circuit board 31, and catching or bowing can be prevented.

The encompassing disposition of the retaining element 4 which is shown generates on the one hand a contact pressure under which the component support 2 cannot be moved away from the detector unit 3 as a result of vibration of the entire assembly. In this case, the retaining element 4 can be constructed such that the component support 2 is pressed against the detector unit 3 with a predetermined defined contact pressure. Even in the event of a thermal load which results in contraction or expansion of the individual elements, this construction is able to ensure that the component support 2 always abuts against the detector unit 3 and in particular against the sensor housing 32. It should be noted that in the exemplary embodiment the component support 2 is seated directly only on the sensor housing 32 and thus a direct mechanical connection is made only between the sensor housing 32 and the component support 2. As a result of the construction shown, of a releasable mechanical connection, in addition to a simple and clear-cut mounting procedure the reliable mechanical connection of combinations of materials which are relatively difficult to connect is also made possible. Moreover, this releasable mechanical connection also makes it possible to ensure that the individual elements can be moved in relation to one another, which means that air trapped between the component support 2 and the detector unit 3, in particular between lenses in the component support 2 and the sensor housing 32, can escape or, in the event of a vacuum, air can flow in as appropriate. Thus, the optical detection system 1 can always be operated in a secure and precise manner.

The shaping of the retaining element 4 is such that the distribution of stress in the assembled condition of the component support 2 and the detector unit 3 can be made as homogeneous as possible.

Not shown in the embodiment of FIG. 1—although it is also possible—is a construction of the retaining element 4 such that, in addition to the mechanical connection between the component support 2 and the detector unit 3, a reliable disposition of the optical detection system 1 on a housing can additionally be made possible, in that the retaining element 4 has additional appropriate securing elements. It is also possible for securing elements to be constructed on the component support 2 and/or on the detector unit 3 and/or the printed circuit board 31, for the purpose of connection to a housing in addition to or instead of these further securing elements on the retaining element 4 for attachment to a housing.

It is also possible for the retaining element 4 to be narrower in width than the printed circuit board 31. In an embodiment of this type, cutouts are advantageously provided in the printed circuit board 31, and the retaining element 4, in particular retaining limbs 46a to 46d (see FIG. 4), extends through these cutouts so that the component support 2 and the detector unit 3 can be reached around and thus also connected securely.

FIG. 2 shows a further sectional illustration along the line of section AA in the illustration of FIG. 1. In addition to the lens 21, a second lens 22 and a third lens 23 are disposed in the component housing 2a of the component support 2. The first lens 21 and the second lens 22 are disposed at a distance from one another as a result of a spacer element 24. As can furthermore be seen, the image sensor 32a is disposed in the sensor housing 32. The image sensor 32a is positioned substantially centrally in the sensor housing 32. Conical elements 32b are constructed on the side of the sensor housing 32 facing the component support 2. A cutout is made in the component base 2b and the component housing 2a such that when the optical detection system 1 is assembled the conical elements 32b engage with a snug fit in this cutout. This means that reliable centering in the x/y plane can be achieved. The two conical elements 32b shown in the sectional illustration are constructed, as seen in a perspective view, as a complete peripheral ring.

FIG. 3 shows, joined together, one half of each of the embodiments of the optical detection system 1 shown in FIG. 1 and FIG. 2.

FIG. 4 is a perspective illustration of the retaining element 4. The bridge-like structure of the retaining element 4 can be clearly seen here. In the illustration shown, the retaining element 4 has four retaining limbs 46a, 46b, 46c and 46d. In this arrangement, each of the retaining limbs 46a to 46d includes the vertical parts 43 and the free ends 44. It can be seen that a respective arcuate cutout 45 is made between the retaining limbs 46a to 46d constructed on each side.

Moreover, the cutout 41c made in the region 41 of connection can be seen. The cutout 41c extends in the horizontal part 41b of the region 41 of connection and also into the sloping edge regions 41a. The component housing 2a of the component support 2 projects through this cutout 41c. In the exemplary embodiment, the cutout 41c is shaped such that the edge region of the cutout abuts against the outside of the component housing 2a over substantially the complete periphery.

FIG. 5 shows a perspective illustration of the component support 2. The component base 2b and the component housing 2a are illustrated here. Depressions 21b and 22b are made in the upper side of the base plate or component base 2b, that faces the retaining element 4, and the region of connection 41 and in particular the horizontal part 41b of the retaining element 4 come to lie in these depressions in the assembled condition of the optical detection system 1, in particular with snug fit.

FIG. 6 shows a perspective illustration of the detector unit 3. Here, the plurality of electronic components on the printed circuit board 31 can be seen. Moreover, the sensor housing 32 having the plurality of electrical contacts 33 made on all four side edges is shown. The raised annular conical element 32b can be seen on the upper side of the sensor housing 32.

FIG. 7 shows a perspective illustration of an optical detection system 1 in its final assembled condition. The retaining limbs 46a to 46d in this case also abut against the narrow edge regions of the printed circuit board 31.

FIG. 8 shows a further perspective illustration of an optical detection system 1 which has been completely mounted and assembled. Here, the illustration shows in particular a view of the underside 31a of the printed circuit board 31 and, as can be seen here, the securing of the retaining element 4 to this underside 31a.

FIG. 9 shows a schematic plan view of the MQFP sensor. The sensor, which is substantially quadrilateral in the embodiment shown, includes a plurality of electrical contacts 33 on all edge sides. The image sensor 32a is positioned centrally in the sensor housing 32. The conical element 32b can be seen, peripheral in relation to this image sensor 32. Furthermore, the sensor housing 32a has two depressions 32c and 32d in the upper side, that faces the component support 2. The depressions 32c and 32d, which are each in the form of a groove, are made at opposing corner regions of the sensor housing 32. Both the number and the disposition of these depressions 32c and 32d are purely exemplary, and they may be made in a wide variety of ways. Similarly, the shape of the depressions 32c and 32d, which is substantially oval in FIG. 9, may be made in a wide variety of other ways. In the assembled condition of the optical detection system 1, pin elements, which are not illustrated and which are preferably constructed on the component base 2b of the component support 2, engage in these depressions 32c and 32d. This groove/pin connection means that twisting of the component support 2 and/or the detector unit 3 in the z direction (the direction perpendicular to the plane of the figure) can be prevented.

FIG. 10 shows a sectional illustration along the line of section BB in FIG. 9. Only a partial region of the entire sectional face is illustrated, and it can be seen that the depression 32c is made at the edge of the corner region of the sensor housing 32. The groove/pin connection which is clear from FIG. 9 and FIG. 10 may also take the form of a latching connection.

FIG. 11 shows a perspective illustration of a second embodiment of a component support 2′. The component support 2′ includes a component housing 2a′ in which a plurality of optical elements is disposed. A lens 21′ is disposed at the upper side. The component housing 2a′ is secured to a component base 2b′, in particular being connected in one piece therewith.

FIG. 12 shows a perspective illustration of a further embodiment of a detector unit 3′. The detector unit 3′ includes a printed circuit board 31′, with a plurality of electronic components being mounted at least one the side of the printed circuit board 31′ facing the component support 2′. Further mounted on this upper side of the printed circuit board 31′ is a sensor housing 32′. A conical element 32b′ is made on the upper side of the sensor housing 32′, that faces the component support 2′, for the purpose of engagement with the component base 2b′ and where appropriate the component housing 2a′. An image sensor 32a′ is disposed in the sensor housing 32′, as was also the case for the first embodiment, in FIG. 6.

FIG. 13 shows a perspective illustration of a further exemplary embodiment of a retaining element 4′. Unlike the retaining element 4 from the first exemplary embodiment (for example in FIG. 4), no cutout is made in a region 41′ of connection. Furthermore, the retaining element 4′ has securing elements 47 which are each constructed between two retaining limbs 46a, 46b and 46c and 46d respectively. In this arrangement, the securing elements 47 extend from the substantially vertically oriented part 43 in the opposite direction to the retaining limbs 46a, 46b and 46c and 46d respectively. In each case, a cutout hole 48 is made at the end of the securing element 47 facing away from the vertical part 43. In the illustration shown, the securing elements 47 are constructed substantially as vertically oriented strips. As a result of these securing elements 47 and the cutouts 48, securing is made possible, in particular a releasable disposition of the retaining element 4 on a separate housing (not illustrated). The entire optical detection system 1′ can thus be releasably disposed on a housing. In the illustration in FIG. 13, too, the retaining element 4′ is made as a single part and may be releasably connected to both the component support 2′ and the detector unit 3′. This modular construction enables flexible joining together and taking apart of the widest possible range of elements, and moreover ensures optimum tolerance compensation in the assembled condition of the optical detection system 1′.

In the embodiment shown in FIGS. 11 to 13, the retaining element 4′ is brought against the detector unit 3′ in a manner that may be regarded as from below, as seen in the illustration, and reaches around the detector unit 3′ and the component housing 2′ in a manner that may be regarded as from below, for the purpose of mechanically connecting these elements.

FIG. 14 shows in perspective the assembled condition of the optical detection system 1′. Here, it can be seen that the single retaining element 4′ is brought against the detector unit 3′ and in particular the printed circuit board 31′ from below, and the mechanical connection is made such that the region 41′ of connection of the retaining element 4′ abuts at least in certain regions against the underside (not visible) of the printed circuit board 31′. Moreover, the substantially vertically oriented parts 43 of the retaining element 4′ engage in cutouts 34a′ and 34b′ in the printed circuit board 31′. These depressions or cutouts 34a′ and 34b′ are made at opposing edge regions of the printed circuit board 31′ (see FIG. 12). Furthermore, the curved profiles 44a of the four retaining limbs 46a to 46d engage (not visible) with webs 2c′, 2d′, 2e′ and 2f′ which are constructed in the component base 2b′. The curved profiles 44a thus snap-fit over these webs 2c′ to 2f′, as a result of which it may be ensured that the retaining element 4′ is attached in a stable position.

Both the webs 2c′ to 2f′ and the cutouts 34a′ and 34b′ may analogously be constructed in the first exemplary embodiment of the optical detection system 1, in the illustrations in FIGS. 1 to 8.

1-19. (canceled)

20. An optical device, comprising:
a component support and at least one optical element disposed in said component support;
a detector unit disposed such that light entering said component support may be guided through said at least one optical element to said detector unit; and
a retaining element constructed to releasably connect said component support to said detector unit and being releasably connected to at least one of said component support and said detector unit.

21. The optical device according to claim 20, wherein said retaining element is flexible at least in certain regions.

22. The optical device according to claim 21, wherein said retaining element is a spring element.

23. The optical device according to claim 20, wherein said retaining element is a bridge-shaped element.

24. The optical device according to claim 20, wherein said retaining element is formed with a connecting region and at least two retaining limbs disposed at opposite sides of said connecting region.

25. The optical device according to claim 24, wherein each said retaining limb has a free end with a curved profile.

26. The optical device according to claim 25, wherein, in an assembled state of the optical system forming a detection system, the curved profile of a free end abuts against an underside of said detector unit facing away from said component support, or against said component support.

27. The optical device according to claim 24, wherein said connecting region is constructed in a shape of a cup.

28. The optical device according to claim 24, wherein said connecting region is formed with a through cutout.

29. The optical device according to claim 28, wherein, in an assembled state of the optical system forming a detection system, said component support extends through said cutout, wherein said connecting region abuts at least in certain regions against said component support.

30. The optical device according to claim 29, wherein said cutout is dimensioned such that said connecting region abuts against said component support peripherally with a snug fit.

31. The optical device according to claim 20, wherein said retaining element is made at least partly from metal or at least partly from synthetic material.

32. The optical device according to claim 20, wherein said detector unit has at least one blocking means in which, in an assembled state of the optical device forming a detection system, an engagement element of the component support engages.

33. The optical device according to claim 32, wherein said engagement element engages in latching manner.

34. The optical device according to claim 20, wherein said retaining element is constructed on a housing for releasably securing the optical system forming a detection system.

35. The optical device according to claim 20, wherein said detector unit includes an image sensor.

36. The optical device according to claim 20, wherein said component support is a lens tube.

37. The optical device according to claim 20, disposed in a vehicle and associated with a driver assistance system or passenger protection system of the vehicle.

38. A vehicle, comprising an optical device according to claim 20.

39. The vehicle according to claim 38, having a driver assistance system and/or a passenger protection system configured to use data detected by the optical device.
